(19) United States
(12) Patent Application Publication
(10) Pub. No.: US 2020/0207511 A1
(43) Pub. Date: Jul. 2, 2020

(54) SYSTEM AND METHOD FOR MANUFACTURING PALLET WITH EMBEDDED SUPPORT STRUCTURES

(71) Applicant: Paradigm Plastic Pallets, Inc., Evansville, IN (US)

(72) Inventors: Gary W. Morris, Evansville, IN (US); Brian D. Kivisto, Dassel, MN (US)

(21) Appl. No.: 16/640,440

(22) PCT Filed: Aug. 22, 2018
(86) PCT No.: PCT/US18/47546

§ 371 Date: Feb. 20, 2020

Related U.S. Application Data
(60) Provisional application No. 62/548,696, filed on Aug. 22, 2017.

(51) Int. Cl. B65D 19/00; B29C 65/18

(52) U.S. Cl. CPC B65D 19/0073; B29C 65/18; B65D 2519/00034; B65D 2519/00069; B65D 2519/00378; B65D 2519/00273; B65D 2519/00293; B65D 2519/00323; B65D 2519/00333; B65D 2519/00104

(57) ABSTRACT

A system and method are provided for manufacturing a plastic pallet having a plurality of runner assemblies with embedded support structures. Each runner assembly may include a top runner board, a bottom runner board, and a plurality of support structures embedded into the top and bottom runner boards. The pallet may be manufactured using heat to at least partially penetrate and soften the runner boards, to soften the support structures, and to weld the support structures to the runner boards in an embedded manner.

### CROSS REFERENCE TO RELATED APPLICATION

This application claims priority to U.S. Provisional Patent Application Ser. No. 62/548,696, filed Aug. 22, 2017, the disclosure of which is hereby expressly incorporated by reference herein in its entirety.

### FIELD OF THE DISCLOSURE

The present disclosure relates to a system and method for manufacturing a pallet. More particularly, the present disclosure relates to a system and method for manufacturing a pallet with embedded support structures.

### BACKGROUND OF THE DISCLOSURE

Pallets are used for the support, storage, and transportation of articles. Most pallets are constructed of wood, but plastic pallets are also available. Pallets should have adequate strength and stability to withstand rough usage and support heavy loads. However, such pallets should also be efficient and inexpensive to manufacture.

### SUMMARY

The present disclosure provides a system and method for manufacturing a plastic pallet having a plurality of runner assemblies with embedded support structures. Each runner assembly may include a top runner board, a bottom runner board, and a plurality of support structures embedded into the top and bottom runner boards. The pallet may be manufactured using heat to at least partially penetrate and soften the runner boards, to soften the support structures, and to weld the support structures to the runner boards in an embedded manner.

According to an embodiment of the present disclosure, a method is provided for manufacturing a plastic pallet having a first board, a second board, and at least one support structure. The method includes the steps of: heating the first board to form a first opening in the first board; heating a first end of the at least one support structure; and welding the first end of the at least one support structure to the first board with the first end of the at least one support structure extending through the first opening in the first board.

According to another embodiment of the present disclosure, a system is provided for manufacturing a plastic pallet having a first board, a second board, and at least one support structure. The system includes: a first jaw configured to hold the first board; a second jaw configured to hold the at least one support structure; and a heated platen. The system also has: a first heating configuration in which the heated platen is positioned between the first board on the first jaw and the at least one support structure on the second jaw; and a first welding configuration in which the heated platen is withdrawn and the at least one support structure is embedded into the first board.

According to yet another embodiment of the present disclosure, a plastic pallet is provided including: a first board made of plastic and having a first opening; a second board made of plastic and having a second opening; and at least one support structure made of plastic and having a first end welded to the first board with the first end extending through the first opening in the first board, and a second end welded to the second board with the second end extending through the second opening in the second board.

### BRIEF DESCRIPTION OF THE DRAWINGS

The above-mentioned and other features and advantages of this disclosure, and the manner of attaining them, will become more apparent and will be better understood by reference to the following description of embodiments of the invention taken in conjunction with the accompanying drawings, wherein:

FIG. 1 is a perspective view of an exemplary pallet of the present disclosure, the pallet including a plurality of top boards, a plurality of bottom hoards, and a plurality of runner assemblies;

FIG. 2 is an elevational view of a top board of FIG. 1;

FIG. 3 is an elevational view of a bottom board of FIG. 1;

FIG. 4 is a perspective view of a runner assembly of FIG. 1;

FIG. 5 is a perspective view of an exemplary manufacturing system of the present disclosure, the system including a first jaw, a second jaw, and a heated platen;

FIG. 6 is a plan view of the first jaw of FIG. 5;

FIG. 7 is a plan view of the second jaw of FIG. 5;

FIG. 8 is a plan view of the heated platen of FIG. 5, the heated platen including a plurality of inserts with board-heating features and support-heating features;

FIG. 9 is a perspective view of an insert of FIG. 8;

FIG. 10 is an elevational view of the insert of FIG. 9;

FIG. 11 is a plan view of the system of FIG. 5 shown in a first starting configuration;

FIG. 12 is a plan view of the system of FIG. 5 shown in a first heating configuration;

FIG. 13 is a plan view of the system of FIG. 5 shown in a first intermediate configuration;

FIG. 14 is a plan view of the system of FIG. 5 shown in a first welding configuration;

FIG. 15 is a plan view of the system of FIG. 5 shown in a second starting configuration;

FIG. 16 is a plan view of the system of FIG. 5 shown in a second heating configuration;

FIG. 17 is a plan view of the system of FIG. 5 shown in a second intermediate configuration; and

FIG. 18 is a plan view of the system of FIG. 5 shown in a second welding configuration,

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

### 1. Pallet

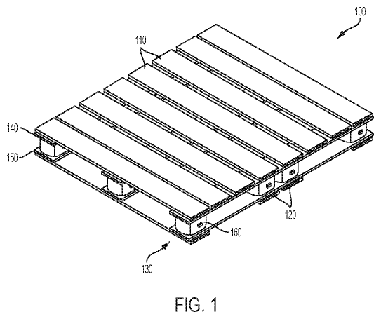

Referring initially to FIG. 1, an exemplary pallet 100 is shown for supporting, storing, and transporting articles. The illustrative pallet 100 includes a plurality of top boards 110 configured to support the articles, a plurality of bottom boards 120 configured to rest upon the ground, and a plurality of runner assemblies 130 positioned therebetween. Each runner assembly 130 may include a top runner board 140, a bottom runner board 150, and a plurality of runner supports 160 extending therebetween. Each element of pallet 100 is described further below.

Top boards 110 and bottom boards 120 may extend generally parallel to each other and generally perpendicular to runner assemblies 130. In the illustrated embodiment of FIG. 1, for example, top boards 110 and bottom boards 120 extend front to back, and runner assemblies 130 extend side to side.

Pallet 100 may be constructed partially or entirely from plastic materials, including, but not limited to, high density polyethylene, polypropylene, nylon, polyvinyl chloride (PVC), or another extrudeable plastic material, as well as mixtures of those plastic materials with other substances such as wood powder, calcium carbonate, and talc. The individual components of pallet 100, including top boards 110, bottom boards 120, and runner assemblies 130, may be formed by any plastic formation method well-known in the art, including, but not limited to, extrusion, injection molding, thermoforming, rotational molding, and vacuum molding. Extrusion, in particular, may be advantageous due to the low start-up costs, the low tooling costs, the ability to use recycled materials for manufacturing, the flexibility, and the high production rate. Each element of pallet 100 may be constructed to have a minimum weight but enough strength to support the desired load. Pallet 100 may be assembled using any method well-known in the art, including, but not limited to, ultrasonic welding, hot plate welding, vibration welding, extrusion seam welding, and combinations thereof.

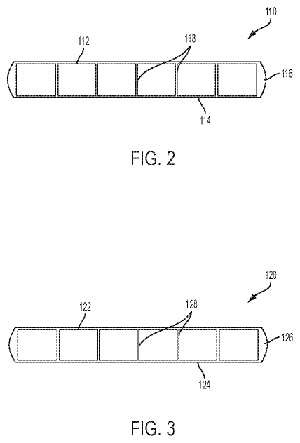

Referring next to FIG. 2, one end of an exemplary top board 110 is shown. The illustrative top board 110 is an elongate and generally hollow structure. The illustrative top board 110 has a top platform 112 configured to support the articles and a bottom platform 114 configured to contact the intermediate runner assemblies 130 (FIG. 1). Top platform 112 of top board 110 may be textured (e.g., roughened) for slip-resistance. Between top platform 112 and bottom platform 114, the illustrative top board 110 also has two outer walls 116, which may be rounded to promote deflection, as well as one or more interior supports 118 for additional strength. As discussed above, top board 110 may be formed by extrusion or another suitable method.

Referring next to FIG. 3, one end of an exemplary bottom board 120 is shown. The illustrative bottom board 120 is an elongate and generally hollow structure that is substantially similar or identical in size and construction to top board 110 of FIG. 2, which increases the efficiency of the manufacturing process. The illustrative bottom board 120 has a top platform 122 configured to contact the intermediate runner assemblies 130 (FIG. 1) and a bottom platform 124 configured to contact the ground. Between top platform 122 and bottom platform 124, the illustrative bottom board 120 has two outer walls 126, which may be rounded to promote deflection, as well as one or more interior supports 128 for additional strength. As discussed above, bottom board 120 may be formed by extrusion or another suitable method.

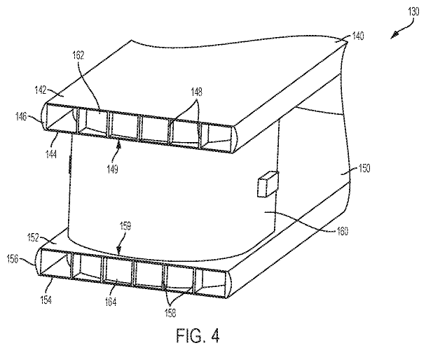

Referring next to FIG. 4, one end of an exemplary runner assembly 130 is shown. As indicated above, the illustrative runner assembly 130 includes top runner board 140, bottom runner board 150, and a plurality of runner supports 160 extending therebetween, each of which is described further below.

The illustrative top runner board 140 of each runner assembly 130 is an elongate and generally hollow structure that is substantially similar or identical in size and construction to top board 110 of FIG. 2 and/or bottom board 120 of FIG. 3, which increases the efficiency of the manufacturing process. The illustrative top runner board 140 has a top platform 142 configured to contact the top board 110 (FIG. 1) and a bottom platform 144. Between top platform 142 and bottom platform 144, the illustrative top runner board 140 has two outer walls 146, which may be rounded to promote deflection, as well as one or more interior supports 148 for additional strength. As discussed above, top runner board 140 may be formed by extrusion or another suitable method.

The illustrative bottom runner board 150 of each runner assembly 130 is an elongate and generally hollow structure that is substantially similar or identical in size and construction to top board 110 of FIG. 2, bottom board 120 of FIG. 3, and/or top runner board 140 of FIG. 4, which increases the efficiency of the manufacturing process. The illustrative bottom runner board 150 has a top platform 152 and a bottom platform 154 configured to contact the bottom board 120 (FIG. 1). Between top platform 152 and bottom platform 154, the illustrative bottom runner board 150 has two outer walls 156, which may be rounded to promote deflection, as well as one or more interior supports 158 for additional strength. As discussed above, bottom runner board 150 may be formed by extrusion or another suitable method.

Referring still to FIG. 4, each runner support 160 extends vertically between top runner board 140 and bottom runner board 150 of runner assembly 130. The illustrative runner support 160 is a substantially hollow, oval-shaped tube, but the shape and size (e.g., thickness, height) of runner support 160 may vary depending on the desired load. The number of runner supports 160 and the spacing between adjacent runner supports 160 may also vary depending on the desired load.

According to an exemplary embodiment of the present disclosure, each runner support 160 is embedded into top runner board 140 and/or bottom runner board 150 of runner assembly 130. In the illustrated embodiment of FIG. 4, for example, a top end 162 of each runner support 160 extends through opening 149 in bottom platform 144 of top runner board 140 and contacts top platform 142 of top runner board 140. In this embedded arrangement, both top platform 142 of top runner board 140 and bottom platform 144 of top runner board 140 (around opening 149) cooperate to support top end 162 of runner support 160. Similarly, a bottom end 164 of each runner support 160 extends through opening 159 in top platform 152 of bottom runner board 150 and contacts bottom platform 156 of bottom runner board 150. In this embedded arrangement, both top platform 152 of bottom runner board 150 (around opening 159) and bottom platform 154 of bottom runner board 150 cooperate to support bottom end 164 of runner support 160. The embedded nature of runner supports 160 may stabilize and strengthen pallet 100.

Other details regarding pallet 100 are disclosed in U.S. Pat. Nos. 7,926,431 and 8,261,675, the disclosures of which are expressly incorporated herein by reference in their entirety.

### 2. Manufacturing System

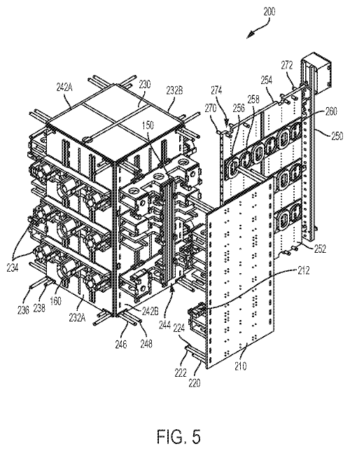

Referring next to FIGS. 5-10, an exemplary system 200 is shown for manufacturing pallet 100 (FIG. 1), more specifically runner assemblies 130 of pallet 100 (FIG. 4). System 200 includes a first jaw 210 configured to hold certain elements of runner assembly 130 and a second jaw 230 configured to hold adjacent elements of runner assembly 130. System 200 also includes a heat source or platen 250 moveable between first jaw 210 and second jaw 230 to heat and attach the adjacent elements of runner assembly 130 together, as discussed further below.

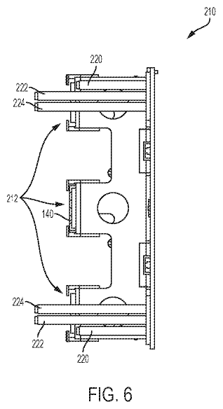

First jaw 210 of system 200 is shown in FIGS. 5 and 6 and includes one or more slots 212 each configured to hold top runner board 140 and/or bottom runner board 150 of runner assembly 130 (FIG. 4). The illustrative first jaw 210 includes three vertical slots 212 such that first jaw 210 is configured to hold three vertical runner boards 140, 150, but this number and arrangement may vary.

First jaw 210 may include a plurality of depth-control pins. In the illustrated embodiment of FIG. 6, first jaw 210 includes at least one first pin 220 that is relatively short, at least one second pin 222 that is relatively long, and at least one third pin 224 having the same length as second pin 222.

First jaw 210 may be configured to move (e.g., slide, rotate) to selectively interact with second jaw 230 and the heated platen 250. Such movement may also facilitate loading and unloading of the corresponding components of runner assembly 130.

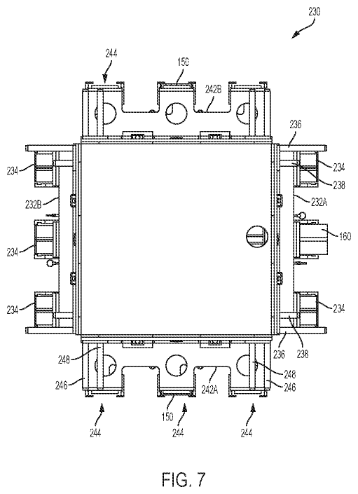

Second jaw 230 of system 200 is shown in FIGS. 5 and 7 and includes one or more support-holding (e.g., tube-holding) faces 232 and one or more board-holding faces 242. The illustrative second jaw 230 is a box-shaped component having two tube-holding faces 232A, 232B positioned on opposite sides of the second jaw 230 and two board-holding faces 242A, 242B positioned on opposite sides of the second jaw 230, but this number and arrangement may vary. Each tube-holding face 232A, 232B of the second jaw 230 includes one or more pegs 234 each configured to hold a runner support 160 of runner assembly 130 (FIG. 4), The illustrative second jaw 230 includes three vertical rows of three pegs 234 on each tube-holding face 232A, 232B such that each tube-holding face 232A, 232B is configured to hold three vertical rows of three runner supports 160 (i.e., nine total runner supports 160), but this number and arrangement may vary. Each board-holding face 242A, 242B of the second jaw 230 includes one or more slots 244 configured to hold top runner board 140 and/or bottom runner board 150 of runner assembly 130 (FIG. 4). The illustrative second jaw 230 includes three vertical slots 244 on each board-holding face 242A, 242B such that each board-holding face 242A, 242B of second jaw 230 is configured to hold three vertical runner boards 140, 150, but this number and arrangement may vary.

Second jaw 230 may include a plurality of depth-control pins. In the illustrated embodiment of FIG. 7, each tube-holding face 232A, 232B of second jaw 230 includes at least one first pin 236 that is relatively long and at least one second pin 238 that is relatively short, and each board-holding face 242A, 242B of second jaw 230 includes at least one first pin 246 that is relatively long and at least one second pin 248 having the same length as first pin 246.

Second jaw 230 may be configured to move (e.g., slide, rotate) to selectively interact with first jaw 210 and the heated platen 250. Second jaw 230 may be configured to rotate to expose tube-holding faces 232A, 232B and board-holding faces 242A, 242B to first jaw 210 and the heated platen 250 in a consecutively alternating manner. Such movement may also facilitate loading and unloading of the corresponding components of runner assembly 130.

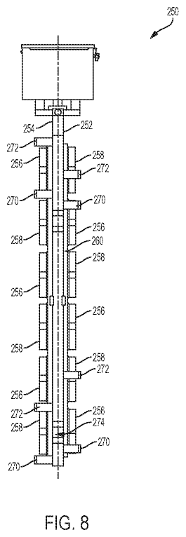

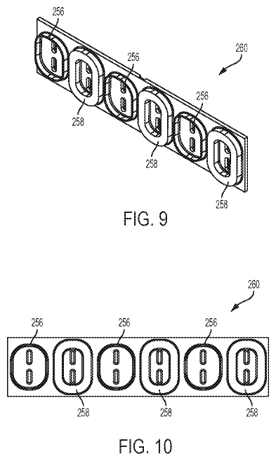

The heated platen 250 of the system 200 is shown in FIGS. 5 and 8 and includes a first face 252 configured to interact with first jaw 210 and a second face 254 configured to interact with second jaw 230. Each face 252, 254 of the heated platen 250 includes one or more raised board-heating features 256 each having a relatively thin wall that is configured to at least partially penetrate (i.e., cut through) and melt or soften an adjacent runner board 140, 150, and one or more raised support-heating (e.g., tube-heating) features 258 each having a relatively thick wall that is configured to melt or soften an adjacent runner support 160, as described further below. The board-heating features 256 and the tube-heating features 258 may be arranged on one or more heated inserts 260. Inserts 260 may be constructed of metal or another suitable material to convey heat from the heated platen 250 to the adjacent runner boards 140, 150 and/or runner supports 160. The illustrative heated platen 250 includes three inserts 260 on first face 252 and three inserts 260 on second face 254 (i.e., six total inserts 260). As shown in FIGS. 9 and 10, each insert 260 illustratively includes three board-heating features 256 and three tube-heating features 258 arranged in an alternating pattern, but this number and arrangement may vary. Inserts 260 on first face 252 may be oriented 180 degrees relative to inserts 260 on second face 254, such that the heated platen 250 includes a board-heating feature 256 on first face 252 aligned with an opposing tube-heating feature 258 on second face 254, and vice versa.

The heated platen 250 may include a plurality of depth-control pins. In the illustrated embodiment of FIG. 8, the heated platen 250 includes a first set of pins 270 on first and second faces 252, 254, and a second set of pins 272 on first and second faces 252, 254. The heated platen 250 also includes one or more passageways 274 to accommodate adjacent depth-control pins of first jaw 210 and/or second jaw 230, as discussed further below.

The heated platen 250 may be configured to move (e.g., slide) in and out between first jaw 210 and second jaw 230.

### 3. Manufacturing Method

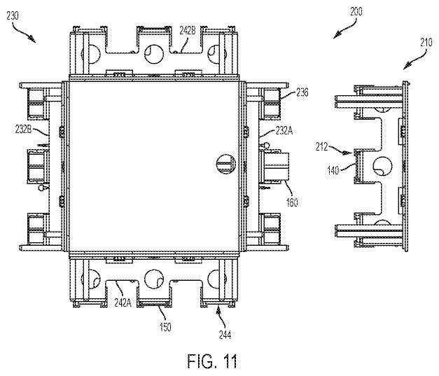

Referring next to FIGS. 11-18, an exemplary method is shown for using system 200 to manufacture pallet 100 (FIG. 1), more specifically runner assemblies 130 of pallet 100 (FIG. 4).

A first starting configuration is shown in FIG. 11. In this configuration, the operator loads first jaw 210 by placing runner boards 140 in slots 212. The operator also loads tube-holding face 232A of second jaw 230 by placing runner supports 160 on pegs 234 and loads board-holding face 242A of second jaw 230 by placing runner boards 150 in slots 244.

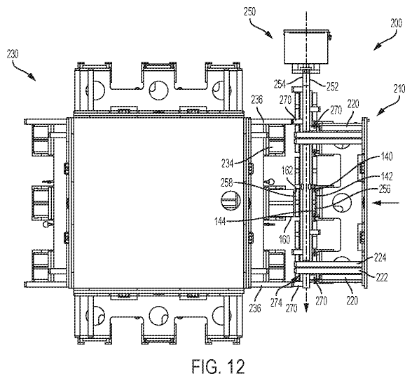

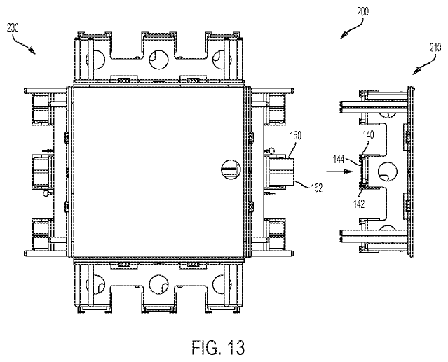

A first welding configuration is shown in FIG. 12. In this configuration, the heated platen 250 moves to a first heating position between first jaw 210 and second jaw 230, and first jaw 210 moves toward the heated platen 250. The desired configuration may be achieved when first pins 220 on first jaw 210 and first pins 236 on tube-holding face 232A of second jaw 230 abut the first set of pins 270 on the heated platen 250. The longer second pins 222 and third pins 224 on first jaw 210 may pass freely through passageways 274 of the heated platen 250. With the heated platen 250 in the first heating position, first face 252 of the heated platen 250 interacts with runner boards 140 on first jaw 210 and second face 254 of the heated platen 250 interacts with runner supports 160 on tube-holding face 232A of second jaw 230. More specifically, the board-heating features 256 on first face 252 are aligned with runner boards 140 on first jaw 210, and the tube-heating features 258 on the opposing second face 254 are aligned with runner supports 160 on second jaw 230. The heated platen 250 may remain in this first heating position for a predetermined period of time to adequately heat runner boards 140 and runner supports 160, such as about 1 to 10 seconds, more specifically about 8 seconds. During this heating period, the board-heating features 256 on first face 252 may: (1) penetrate the near, bottom platform 144 of each runner board 140 to form opening 149 (FIG. 4), (2) soften the near, bottom platform 144 around opening 149 (FIG. 4), and (3) soften the far, top platform 142 of each runner board 140 without completely penetrating the top platform 142. At the same time, the tube-heating features 258 on the opposing second face 254 may soften top end 162 of each runner support 160.

A first intermediate configuration is shown in FIG. 13. In this configuration, first jaw 210 moves away from the heated platen 250, and the heated platen 250 is withdrawn, The heated runner supports 160 are now ready for attachment to the heated runner boards 140.

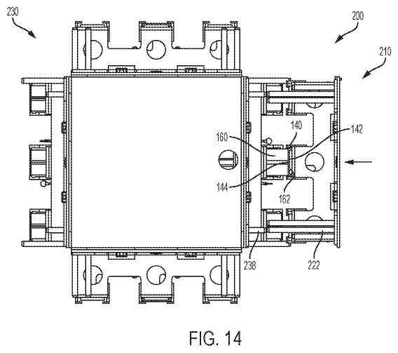

A first welding configuration is shown in FIG. 14. In this configuration, first jaw 210 moves quickly back toward second jaw 230 to attach the still-heated runner supports 160 to the still-heated runner boards 140. The desired configuration may be achieved when second pins 222 on first jaw 210 abut second pins 238 on tube-holding face 232A of second jaw 230. Each runner support 160 may be embedded into the corresponding runner board 140 by moving the softened top end 162 of each runner support 160 through the cut bottom platform 144 of each runner board 140 and into engagement with the softened top platform 142 of each runner board 140 (See also FIG. 4). System 200 may remain in this configuration for a predetermined period of time to adequately attach runner supports 160 to runner boards 140, such as about 1 to 10 seconds, more specifically about 4 seconds.

A second starting configuration is shown in FIG. 15. In this configuration, first jaw 210 moves away from second jaw 230. Because runner supports 160 are embedded in runner boards 140, runner supports 160 are pulled away from second jaw 230 and are supported by runner boards 140 on first jaw 210. Also, second jaw 230 rotates 90 degrees to expose runner boards 150 on board-holding face 242A of second jaw 230 to runner supports 160 on first jaw 210.

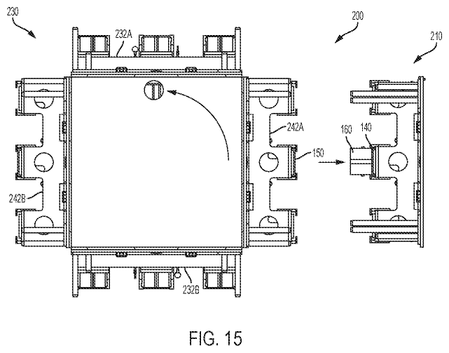

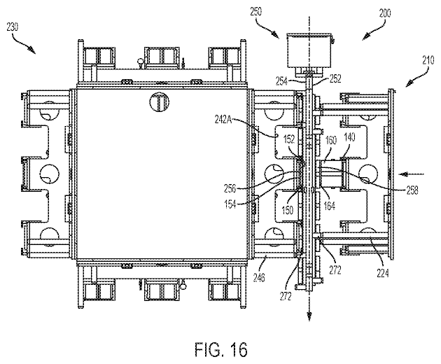

A second heating configuration is shown in FIG. 16. In this configuration, the heated platen 250 moves beyond the first heating position (FIG. 12) to a second heating position between first jaw 210 and second jaw 230, and first jaw 210 moves toward the heated platen 250. The desired configuration may be achieved when third pins 224 on first jaw 210 and first pins 246 on board-holding face 242A of second jaw 230 abut the second set of pins 272 on the heated platen 250. With the heated platen 250 in the second heating position, first face 252 of the heated platen 250 interacts with runner supports 160 on first jaw 210 and second face 254 of the heated platen 250 interacts with runner boards 150 on board-holding face 242A of second jaw 230. More specifically, the tube-heating features 258 on first face 252 are aligned with runner supports 160 on first jaw 210, and the board-heating features 256 on the opposing second face 254 are aligned with runner boards 150 on second jaw 230. The heated platen 250 may remain in this second heating position for a predetermined period of time to adequately heat runner supports 160 and runner boards 150, such as about 1 to 10 seconds, more specifically about 8 seconds. During this heating period, the tube-heating features 258 on first face 252 may soften bottom end 164 of each runner support 160. At the same time, the board-heating features 256 on second face 254 may: (1) penetrate the near, top platform 152 of each runner board 150 to form opening 159 (FIG. 4), (2) soften the near, top platform 152 around opening 159 (FIGS. 4), and (3) soften the far, bottom platform 154 of each runner board 150 without completely penetrating the bottom platform 154.

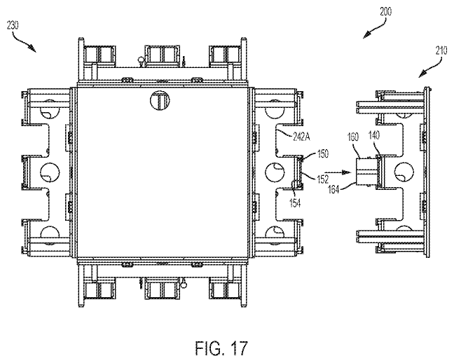

A second intermediate configuration is shown in FIG. 17. In this configuration, first jaw 210 moves away from the heated platen 250, and the heated platen 250 is withdrawn. The heated runner supports 160 are now ready for attachment to the heated runner boards 150.

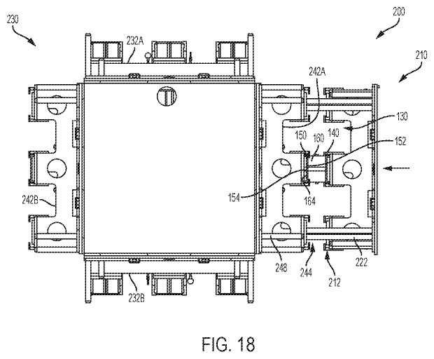

A second welding configuration is shown in FIG. 18. In this configuration, first jaw 210 moves quickly back toward second jaw 230 to attach the still-heated runner supports 160 to the still-heated runner boards 150. The desired configuration may be achieved when second pins 222 on first jaw 210 abut second pins 248 on board-holding face 242A of second jaw 230. Each runner support 160 may be embedded into the corresponding runner board 150 by moving the softened bottom end 164 of each runner support 160 through the cut top platform 152 of each runner board 150 and into engagement with the softened bottom platform 154 of each runner board 150 (See also FIG. 4). System 200 may remain in this configuration for a predetermined period of time to adequately attach runner supports 160 to runner boards 150, such as about 1 to 10 seconds, more specifically about 4 seconds. Finally, the completed runner assemblies 130 may be released from slots 212 of first jaw 210 and slots 244 of second jaw 230 and attached to top boards 110 and bottom boards 120 (FIG. 1).

The method illustrated in FIGS. 11-18 may be performed automatically and quickly, with processing times less than or near one minute. The method may be repeated to manufacture additional runner assemblies 130. For expediency, the continued method may utilize the second tube-holding face 232B and the second board-holding face 242B of second jaw 230.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for manufacturing a plastic pallet having a first board, a second board, and at least one support structure, the method comprising the steps of:
heating the first board to form a first opening in the first board;
heating a first end of the at least one support structure; and
welding the first end of the at least one support structure to the first board with the first end of the at least one support structure extending through the first opening in the first board.

2. The method of claim 1, wherein the steps of heating the first board and heating the at least one support structure are performed simultaneously.

3. The method of claim 1, wherein the steps of heating the first board and heating the at least one support structure are performed using a heated platen having:
a first face that interacts with the first board; and
a second face that interacts with the at least one support structure.

4. The method of claim 1, wherein the first board is a generally hollow structure having a first platform and a second platform, and wherein the step of heating the first board comprises:
forming the first opening in the first platform;
softening the first platform around the first opening; and
softening the second platform.

5. The method of claim 1, further comprising the steps of:
heating the second board to form a second opening in the second board; and
welding a second end of the at least one support structure to the second board with the second end of the at least one support structure extending through the second opening in the second board.

6. A system for manufacturing a plastic pallet having a first board, a second board, and at least one support structure, the system comprising:
a first jaw configured to hold the first board;
a second jaw configured to hold the at least one support structure; and
a heated platen;
wherein the system has:
a first heating configuration in which the heated platen is positioned between the first board on the first jaw and the at least one support structure on the second jaw; and
a first welding configuration in which the heated platen is withdrawn and the at least one support structure is embedded into the first board.

7. The system of claim 6, wherein a first face of the heated platen includes a raised board-heating feature configured to at least partially penetrate and soften the first board in the first heating configuration.

8. The system of claim 6, wherein a second face of the heated platen includes a raised support-heating feature configured to soften the at least one support structure in the first heating configuration.

9. The system of claim 6, wherein the heated platen includes:
a plurality of board-heating features each having a relatively thin wall; and
a plurality of support-heating features each having a relatively thick wall.

10. The system of claim 9, wherein the plurality of board-heating features and the plurality of support-heating features are arranged in an alternating pattern across the heated platen.

11. The system of claim 9, wherein each of the plurality of board-heating features is aligned with a corresponding one of the plurality of support-heating features on opposing faces of the heated platen.

12. The system of claim 6, wherein the first and second jaws are closer together in the first welding configuration than in the first heating configuration.

13. The system of claim 6, wherein:
a first face of the second jaw is configured to hold the at least one support structure; and
a second face of the second jaw is configured to hold the second board.

14. The system of claim 13, wherein the second jaw is rotatable relative to the first jaw to selectively expose the first face or the second face to the first jaw.

15. The system of claim 13, wherein the at least one support structure moves from the second jaw to the first jaw after the first welding configuration.

16. The system of claim 15, wherein the system has:
a second heating configuration in which the heated platen is positioned between the at least one support structure on the first jaw and the second board on the second jaw; and
a second welding configuration in which the heated platen is withdrawn and the at least one support structure is embedded into the second board.

17. The system of claim 16, wherein a position of the heated platen in the first heating configuration is spaced apart from a position of the heated platen in the second heating configuration.

18. A plastic pallet comprising:
a first board made of plastic and having a first opening;
a second board made of plastic and having a second opening; and
at least one support structure made of plastic and having:
a first end welded to the first board with the first end extending through the first opening in the first board; and
a second end welded to the second board with the second end extending through the second opening in the second board.

19. The plastic pallet of claim 18, wherein:
the first board is a generally hollow structure having a first outer platform and a first inner platform that defines the first opening, the first end of the at least one support structure extending through the first opening in the first inner platform and being welded to the first outer platform; and
the second board is a generally hollow structure having a second outer platform and a second inner platform that defines the second opening, the second end of the at least one support structure extending through the second opening in the second inner platform and being welded to the second outer platform.

20. The plastic pallet of claim 18, further comprising:
a plurality of top boards extending generally perpendicular to the first and second boards; and
a plurality of bottom boards extending generally perpendicular to the first and second boards.
